(19) United States
(12) Patent Application Publication
(10) Pub. No.: US 2025/0365378 A1
(43) Pub. Date: Nov. 27, 2025

(54) PAPER SHEET CONVEYANCE DEVICE AND IMAGE FORMING DEVICE COMPRISING THE SAME

(71) Applicant: KONICA MINOLTA, INC., Tokyo (JP)

(72) Inventors: Lei GAO, Wuxi (CN); Peng ZHOU, Wuxi (CN); Jun TANG, Wuxi (CN)

(73) Assignee: KONICA MINOLTA, INC., Tokyo (JP)

(21) Appl. No.: 19/211,754

(22) Filed: May 19, 2025

(30) Foreign Application Priority Data
May 21, 2024 (CN) 202410636836.4

(51) Int. Cl. H04N 1/00

(52) U.S. Cl. CPC H04N 1/00652; H04N 1/00594; H04N 1/00602; H04N 1/00708; H04N 1/00798; H04N 2201/0081

(57) ABSTRACT

Disclosed is a paper sheet conveyance device, including: a pair of conveyance rollers that rotates to convey a paper sheet passing through them; and a driver that drives the pair of conveyance rollers to rotate. The paper sheet conveyance device further includes a hardware processor that controls the driver to drive the pair of conveyance rollers to rotate, such that before the paper sheet breaks into the pair of conveyance rollers, a rotation speed of the pair of conveyance rollers reaches a predetermined conveyance speed, and after the paper sheet is separated from the pair of conveyance rollers, the pair of conveyance rollers continue to rotate to a predetermined position to stop.

### CROSS-REFERENCE TO RELATED APPLICATIONS

This application claims the benefit of priority to Chinese Patent Application No. 202410636836.4, filed on May 21, 2024 with China National Intellectual Property Administration, and entitled “PAPER SHEET CONVEYANCE DEVICE AND IMAGE FORMING DEVICE COMPRISING THE SAME”, the entire disclosure of which is incorporated herein by reference.

### BACKGROUND OF THE INVENTION

### Technical Field

The present disclosure relates to the technical field of image formation, and in particular, to a paper sheet conveyance device and an image forming device comprising the same.

### Description of Related Art

A paper sheet conveyance device is typically provided in an image forming device, in order to convey a paper sheet to a desired position and form an expected image on the conveyed paper sheet.

However, existing paper sheet conveyance devices have conveyance errors in conveying paper sheets, which is not conducive to good performance of a function of an image forming device including at least one of the paper sheet conveyance devices.

### SUMMARY OF THE INVENTION

Embodiments of the present disclosure provide a paper sheet conveyance device and an image forming device comprising the same, and is conducive to reducing a conveyance error of the paper sheet conveyance device, and is helpful for the image forming device comprising the paper sheet conveyance device to play a good function.

Some embodiments of the present disclosure provide a paper sheet conveyance device, including: a pair of conveyance rollers that rotates to convey a paper sheet passing through them; and a driver that drives the pair of conveyance rollers to rotate. The paper sheet conveyance device further includes a hardware processor that controls the driver to drive the pair of conveyance rollers to rotate, such that before the paper sheet breaks into the pair of conveyance rollers, a rotation speed of the pair of conveyance rollers reaches a predetermined conveyance speed, and after the paper sheet is separated from the pair of conveyance rollers, the pair of conveyance rollers continue to rotate to a predetermined position to stop.

Some embodiments of the present disclosure provide an image forming device, including: the paper sheet conveyance device according to claim 1; and an image reader that reads a paper surface of the paper sheet passing through the pair of conveyance rollers, wherein the hardware processor of the paper sheet conveyance device generates size data corresponding to the paper surface based on a time it takes for the paper sheet to pass through the pair of conveyance rollers.

### BRIEF DESCRIPTION OF THE DRAWINGS

Other features and advantages of the present disclosure will be better understood from the following detailed description of specific embodiments with reference to the accompanying drawings, where the same reference numerals identify the same or similar parts, wherein:

FIG. 1 is a schematic stereo view of a paper sheet conveyance device according to an embodiment of the present disclosure.

FIG. 2 is a schematic brief view of the paper sheet conveyance device in FIG. 1.

FIG. 3 is a schematic functional structural view of the paper sheet conveyance device in FIG. 1.

FIG. 4 is a schematic side view of an image forming device according to an embodiment of the present disclosure.

FIG. 5 is a schematic brief stereo view of the image forming device in FIG. 4.

### DETAILED DESCRIPTION

The implementation and application of specific embodiments will be discussed in detail below. However, it should be understood that the specific embodiments discussed only exemplarily illustrate specific ways of implementing and applying the present disclosure, and are not limiting the scope of the present disclosure.

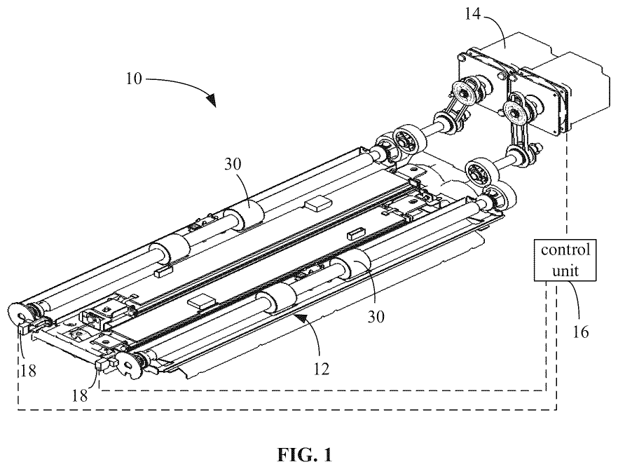

FIG. 1 is a schematic stereo view of a paper sheet conveyance device according to an embodiment of the present disclosure. As shown in FIG. 1, some embodiments of the present disclosure provide a paper sheet conveyance device 10, which includes a pair of conveyance rollers 12, a drive unit (i.e., driver) 14 and a control unit (i.e. hardware processor) 16.

The pair of conveyance rollers 12 is adapted to rotate to convey a paper sheet (not shown) passing through them. The drive unit 14 is adapted to drive the pair of conveyance rollers 12 to rotate or stop. The control unit 16 is adapted to control the drive unit 14 to drive the pair of conveyance rollers 12 to rotate or stop, such that before the paper sheet breaks into the pair of conveyance rollers 12, a rotation speed of the pair of conveyance rollers 12 reaches a predetermined conveyance speed, and after the paper sheet is separated from the pair of conveyance rollers 12, the pair of conveyance rollers 12 continue to rotate to a predetermined position to stop.

Before the paper sheet breaks into the pair of conveyance rollers 12, the rotation speed of the pair of conveyance rollers 12 reaches the predetermined conveyance speed. After the paper sheet is separated from the pair of conveyance rollers 12, the pair of conveyance rollers 12 continue to rotate to the predetermined position to stop. Before a next sheet of paper sheet breaks into the pair of conveyance rollers 12, the pair of conveyance rollers 12 that stop at the predetermined position start to rotate again, and convey the paper sheet when the rotation speed reaches the predetermined conveyance speed again. After the paper sheet is separated from the pair of conveyance rollers 12, the pair of conveyance rollers 12 continue to rotate to the predetermined position and stop. That is, for different paper sheets with a same size, the pair of conveyance rollers 12 always touch these sheets at a same part and convey them. In this way, it can be ensured that, in a process where the paper sheet breaks into the pair of conveyance rollers 12 and is conveyed, for paper sheets with a same size, rotations of the pair of conveyance rollers 12 are the same, which can be conducive to reducing a conveyance error caused by an outer diameter shape tolerance of the pair of conveyance rollers 12.

Herein, the “predetermined position” may refer to an arbitrary position where the pair of conveyance rollers 12 stop after rotating at an arbitrary angle around central axes thereof, as long as it is applicable to the present disclosure. The “predetermined position” may be a position where the pair of conveyance rollers 12 stop after rotating at a predetermined angle around central axes thereof.

The “rotation” refers to an angular displacement generated by the pair of conveyance roller 12 rotating around central axes thereof to a predetermined position, or a length of an arc that has been rotated at a certain point on an outer circumference of the pair of conveyance rollers 12 during the foregoing rotating, and the like.

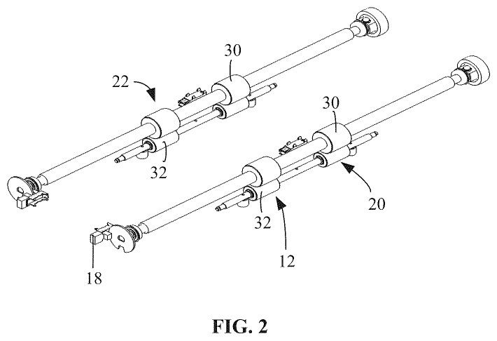

The pair of conveyance rollers 12 may include one pair of conveyance rollers, such as, a driven roller 32 and a driving roller 30 that drives the driven roller 32 to rotate together (see FIG. 2). The rotation of the pair of conveyance rollers 12 may be a rotation of the driving roller 30. The predetermined position of the pair of conveyance rollers 12 may be a predetermined position of the driving roller 30.

The paper sheet conveyance device 10 may be any device suitable for conveying a paper sheet, and may have any possible construction, as long as it is applicable to the present disclosure.

The pair of conveyance rollers 12 may be connected with the drive unit 14, and rotate by virtue of power provided by the drive unit 14, to convey the paper sheet passing through them. When the drive unit 14 does not provide power to the pair of conveyance rollers 12, for example, when the drive unit 14 is not working, the pair of conveyance rollers 12 stop rotating. The control unit 16 may control the drive unit 14 to provide power, does not provide power or provide a certain size of power to the pair of conveyance rollers 12, and then makes the pair of conveyance rollers 12 rotate, stop rotating or rotate at a certain rotation speed.

The pair of conveyance rollers 12, the drive unit 14 and the control unit 16 each may have any possible construction, as long as it is applicable to the present disclosure.

According to some embodiments, the predetermined position is an origin position of the pair of conveyance rollers 12. The origin position may be an arbitrary initial position that the pair of conveyance rollers 12 is at before rotating around central axes thereof.

If the predetermined position is provided as the origin position, before the paper sheet breaks into the pair of conveyance rollers 12, the pair of conveyance rollers 12 start to rotate from the origin position and convey the paper sheet after the rotation speed reaches the predetermined conveyance speed, and after the paper sheet is separated from the pair of conveyance rollers 12, the pair of conveyance rollers 12 continue to rotate back to the origin position and stop. Before a next sheet of paper sheet breaks into the pair of conveyance rollers 12, the pair of conveyance rollers 12 that stop at the origin position start to rotate again, and convey the paper sheet when the rotation speed reaches the predetermined conveyance speed again. After the paper sheet is separated from the pair of conveyance rollers 12, the pair of conveyance rollers 12 continue to rotate back to the origin position and stop. In this way, it can be ensured that, in a process where the paper sheet breaks into the pair of conveyance rollers 12 and is conveyed, for paper sheets with a same size, rotations of the pair of conveyance rollers 12 are the same. As a result, the conveyance error caused by the outer diameter shape tolerance of the pair of conveyance rollers 12 can be reduced.

According to some embodiments, the paper sheet conveyance device 10 further includes a position sensor 18. The position sensor 18 is adapted to detect a rotational phase of the pair of conveyance rollers 12. For example, the position sensor 18 may be used in conjunction with a shading turntable, and when the position sensor 18 is switched between high and low potentials, the control unit 16 may begin to record a rotation step of the drive unit 14, and may calculate an angle at which the pair of conveyance rollers 12 rotate, that is, an angular displacement of the pair of conveyance rollers 12, according to a reduction ratio of the drive unit 14. The control unit 16 is configured to control the drive unit 14 to drive the pair of conveyance rollers 12 to continue rotating or stop rotating based on a detection result of the position sensor 18.

The position sensor 18 may have any possible construction, as long as it is applicable to the present disclosure. For example, the position sensor 18 may include a photoelectric sensor or an encoder, and the like.

When the paper sheet conveyance device 10 begins to convey the paper sheet, the position sensor 18 may send a trigger signal to the control unit 16, and then, the control unit 16 controls the drive unit 14 to drive the pair of conveyance rollers 12 to start rotating, and to drive the pair of conveyance rollers 12 to increase the rotation speed to the predetermined conveyance speed before the paper sheet breaks into the pair of conveyance rollers 12.

After the paper sheet breaks into the pair of conveyance rollers 12, the control unit 16 may control the drive unit 14 to drive the pair of conveyance rollers 12 to convey the paper sheet at the predetermined conveyance speed.

After the paper sheet is separated from the pair of conveyance rollers 12, the position sensor 18 may send a detected rotational phase of the pair of conveyance rollers 12 to the control unit 16, to determine by the control unit 16 whether the pair of conveyance rollers 12 have rotated to the predetermined position. If the control unit 16 determines that the pair of conveyance rollers 12 have rotated to the predetermined position, the control unit 16 may control the drive unit 14 to drive the pair of conveyance rollers 12 to stop rotating. If the control unit 16 determines that the pair of conveyance rollers 12 has not rotated to the predetermined position, the control unit 16 may control the drive unit 14 to drive the pair of conveyance rollers 12 to continue to rotate, until the control unit 16 determines that the pair of conveyance rollers 12 has rotated to the predetermined position based on the detection result of the position sensor 18, then the control unit 16 controls the drive unit 14 to drive the pair of conveyance rollers 12 to stop rotating.

FIG. 2 is a schematic brief view of the paper sheet conveyance device in FIG. 1. As shown in FIG. 2, in some embodiments, the pair of conveyance rollers 12 include an upstream conveyance roller pair 20 and a downstream conveyance roller pair 22. The control unit 16 is configured to control the drive unit 14 to drive the upstream conveyance roller pair 20 and the downstream conveyance roller pair 22 to rotate, respectively, to convey the paper sheet passing through them.

The upstream conveyance roller pair 20 and the downstream conveyance roller pair 22 each may have any possible construction, as long as it is applicable to the present disclosure. The upstream conveyance roller pair 20 and the downstream conveyance roller pair 22 may be the same as or different from each other.

Unless otherwise specified, the terms “upstream” and “downstream” as used herein refer to an upstream and a downstream of a paper sheet conveyance route and similar meanings.

When the paper sheet is conveyed along the conveyance route, it first breaks into the upstream conveyance roller pair 20 and is conveyed, and then breaks into the downstream conveyance roller pair 22 and to be sequentially conveyed after being separated from the upstream conveyance roller pair 20.

Specifically, as shown in FIGS. 1 and 2, when the paper sheet conveyance device 10 conveys the paper sheet, the position sensor 18 at the upstream conveyance roller pair 20 may send a trigger signal to the control unit 16, and then, the control unit 16 controls the drive unit 14 to drive the upstream conveyance roller pair 20 to start rotating, and to drive the upstream conveyance roller pair 20 to increase the rotation speed to an upstream predetermined conveyance speed before the paper sheet breaks into the upstream conveyance roller pair 20. After the paper sheet breaks into the upstream conveyance roller pair 20, the control unit 16 may control the drive unit 14 to drive the upstream conveyance roller pair 20 to convey the paper sheet at the predetermined conveyance speed. After the paper sheet is separated from the upstream conveyance roller pair 20, the position sensor 18 may send a detected rotational phase of the upstream conveyance roller pair 20 to the control unit 16, to determine by the control unit 16 whether the upstream conveyance roller pair 20 has rotated to an upstream predetermined position. If the control unit 16 determines that the upstream conveyance roller pair 20 has rotated to the upstream predetermined position, the control unit 16 may control the drive unit 14 to drive the upstream conveyance roller pair 20 to stop rotating. If the control unit 16 determines that the upstream conveyance roller pair 20 has not rotated to the upstream predetermined position, the control unit 16 may control the drive unit 14 to drive the upstream conveyance roller pair 20 to continue to rotate, until the control unit 16 determines that the upstream conveyance roller pair 20 has rotated to the upstream predetermined position based on the detection result of the position sensor 18, then the control unit 16 controls the drive unit 14 to drive the upstream conveyance roller pair 20 to stop rotating.

After the paper sheet is separated from the upstream conveyance roller pair 20 and before the paper sheet breaks into the downstream conveyance roller pair 22, the position sensor 18 at the downstream conveyance roller pair 22 may send a trigger signal to the control unit 16, and then, the control unit 16 controls the drive unit 14 to drive the downstream conveyance roller pair 22 to start rotating, and to drive the downstream conveyance roller pair 22 to increase the rotation speed to a downstream predetermined conveyance speed before the paper sheet breaks into the downstream conveyance roller pair 22. After the paper sheet breaks into the downstream conveyance roller pair 22, the control unit 16 may control the drive unit 14 to drive the downstream conveyance roller pair 22 to convey the paper sheet at a downstream predetermined conveyance speed. After the paper sheet is separated from the downstream conveyance roller pair 22, the position sensor 18 may send a detected rotational phase of the downstream conveyance roller pair 22 to the control unit 16, to determine by the control unit 16 whether the downstream conveyance roller pair 22 has rotated to a downstream predetermined position. If the control unit 16 determines that the downstream conveyance roller pair 22 has rotated to the downstream predetermined position, the control unit 16 may control the drive unit 14 to drive the downstream conveyance roller pair 22 to stop rotating. If the control unit 16 determines that the downstream conveyance roller pair 22 has not rotated to the downstream predetermined position, the control unit 16 may control the drive unit 14 to drive the downstream conveyance roller pair 22 to continue to rotate, until the control unit 16 determines that the downstream conveyance roller pair 22 has rotated to the downstream predetermined position based on the detection result of the position sensor 18, then the control unit 16 controls the drive unit 14 to drive the downstream conveyance roller pair 22 to stop rotating.

The position sensor 18 at the upstream conveyance roller pair 20 (hereinafter referred to as the upstream position sensor 18) and the position sensor 18 at the downstream conveyance roller pair 22 (hereinafter referred to as the downstream position sensor 18) may be the same as or different from each other.

The upstream predetermined conveyance speed and the downstream predetermined conveyance speed may be the same as or different from each other. In general, the upstream predetermined conveyance speed is less than the downstream predetermined conveyance speed, such that the paper sheet may be conveyed smoothly in the conveyance route.

The upstream predetermined position may be an arbitrary position where the upstream conveyance roller pair 20 stops after rotating at an arbitrary angle around a central axis thereof, as long as it is applicable to the present disclosure. The upstream predetermined position may be a position where the upstream conveyance roller pair 20 stops after rotating at an upstream predetermined angle around a central axis thereof. For example, the upstream predetermined position may be an origin position of the upstream conveyance roller pair 20. The downstream predetermined position may be an arbitrary position where the downstream conveyance roller pair 22 stops after rotating at an arbitrary angle around a central axis thereof, as long as it is applicable to the present disclosure. The downstream predetermined position may be a position where the downstream conveyance roller pair 22 stops after rotating at a downstream predetermined angle around a central axis thereof. For example, the downstream predetermined position may be an origin position of the downstream handling roller pair 22. The upstream predetermined angle and the downstream predetermined angle may be the same as or different from each other.

A process of the upstream conveyance roller pair 20 continuing to rotate to the upstream predetermined position and stopping after the paper sheet is separated therefrom and a process of the downstream conveyance roller pair 22 continuing to rotate to the downstream predetermined position and stopping after the paper sheet is separated therefrom, as described above, may be separate from each other. The upstream conveyance roller pair 20 and the downstream conveyance roller pair 22 may stop rotating successively or stop rotating at the same time. For example, after the paper sheet is separated from the upstream conveyance roller pair 20, after the control unit 16 determines whether the upstream conveyance roller pair 20 has rotated to the upstream predetermined position based on a detection result of the upstream position sensor 18, the control unit 16 may directly control the drive unit 14 to drive the upstream conveyance roller pair 20 to rotate to the upstream predetermined position to stop, regardless of whether the downstream conveyance roller pair 22 is in a state of rotating or stopping. Alternatively, after the paper sheet is separated from the upstream conveyance roller pair 20, the control unit 16 may drive the upstream conveyance roller pair 20 to continue to rotate, until the control unit 16 controls the drive unit 14 to drive the upstream conveyance roller pair 20 and the downstream conveyance roller pair 22 to rotate to the upstream predetermined position and the downstream predetermined position to stop, respectively, after the paper sheet is separated from the downstream conveyance roller pair 22, and after the control unit 16 determines whether the upstream conveyance roller pair 20 and the downstream conveyance roller pair 22 have rotated to the upstream predetermined position and the downstream predetermined position, respectively, based on the detection results of the upstream position sensor 18 and the downstream position sensor 18. Alternatively, after the paper sheet is separated from the upstream conveyance roller pair 20, the control unit 16 may control the drive unit 14 to drive the upstream conveyance roller pair 20 to stop rotating, until after the paper sheet is separated from the downstream conveyance roller pair 22, and after the control unit 16 determines whether the upstream conveyance roller pair 20 and the downstream conveyance roller pair 22 have rotated to the upstream predetermined position and the downstream predetermined position, respectively, based on the detection results of the upstream position sensor 18 and the downstream position sensor 18, the control unit 16 controls the drive unit 14 to drive the upstream conveyance roller pair 20 and the downstream conveyance roller pair 22 to rotate to the upstream predetermined position and the downstream predetermined position to stop, respectively.

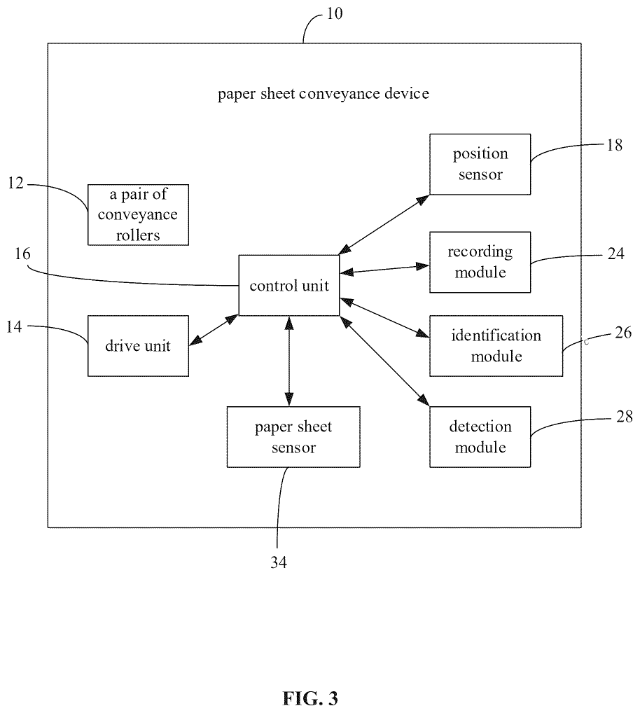

FIG. 3 is a schematic functional structural view of the paper sheet conveyance device in FIG. 1. As shown in FIG. 3, in some embodiments, the paper sheet conveyance device 10 further includes a recording module 24. The recording module 24 is adapted to record a number of the paper sheet passing through the pair of conveyance rollers 12 and/or to record a rotation time of the pair of conveyance rollers 12. The control unit 16 is configured to determine whether to change the origin position based on a result of the recording module 24.

As described above, the origin position may be an arbitrary initial position that the pair of conveyance rollers 12 is at before rotating around central axes thereof. The initial position may be any position along a circumferential direction of the pair of conveyance rollers 12. When the origin position is changed, a contact point between the paper sheet and the pair of conveyance rollers 12 when the paper sheet breaks into the pair of conveyance rollers 12, that is, a break-in site of the paper sheet relative to the pair of conveyance rollers 12, may be correspondingly changed, which can reduce wear of the pair of conveyance rollers 12 by the paper sheet, can be conducive to improving a service life of the pair of conveyance rollers 12, and further helps to reduce the conveyance error caused by the outer diameter shape tolerance of the pair of conveyance rollers 12.

The recording module 24 can record the number of the paper sheet passing through the pair of conveyance rollers 12 and/or record the rotation time of the pair of conveyance rollers 12, and can send these recording results to the control unit 16. The control unit 16 may calculate a number increment of the paper sheet passing through the pair of conveyance rollers 12 and/or a rotation time increment of the pair of conveyance rollers 12 based on the recording result of the recording module 24, and determine whether the number increment of the paper sheet passing through the pair of conveyance rollers 12 and/or the rotation time increment of the pair of conveyance rollers 12 has reached a predetermined number increment or a predetermined time increment. If either of the number increment of the paper sheet passing through the pair of conveyance rollers 12 and the rotation time increment of the pair of conveyance rollers 12 reaches its corresponding predetermined number increment or the predetermined time increment, the control unit 16 may change the origin position, such that after the paper sheet is separated from the pair of conveyance rollers 12, the drive unit 14 drives the pair of conveyance rollers 12 to continue to rotate to a changed origin position to stop. Specifically, in a subsequent paper sheet conveyance process, after the position sensor 18 sends the detected rotational phase of the pair of conveyance rollers 12 to the control unit 16, the control unit 16 may determine whether the pair of conveyance rollers 12 has rotated to the foregoing changed origin position described above, and then control the drive unit 14 to drive the pair of conveyance rollers 12 to stop rotating or continue to rotate, such that the pair of conveyance rollers 12 stops rotating at the foregoing changed origin position. If both the number increment of the paper sheets passing through the pair of conveyance rollers 12 and the rotation time increment of the pair of conveyance rollers 12 do not reach their corresponding predetermined number increment or the predetermined time increment, the control unit 16 does not change the origin position, such that after the paper sheet is separated from the pair of conveyance rollers 12, the drive unit 14 drives the pair of conveyance rollers 12 to continue to rotate to the current origin position to stop. That is, whenever the paper sheet conveyance device 10 conveys a predetermined number of paper sheets, or whenever the pair of conveyance rollers 12 rotates for a predetermined time, the control unit 16 may change the origin position once.

The recording module 24 may have any possible construction, as long as it is applicable to the present disclosure.

According to some embodiments, the paper sheet conveyance device 10 further includes an identification module 26. The identification module 26 is adapted to identify a type of the paper sheet. The control unit 16 is configured to determine whether to change the origin position based on the type of the paper sheet. Changing the origin position can reduce wear of the pair of conveyance rollers 12 by the paper sheet, can help to improve a service life of the pair of conveyance rollers 12, and can further help to reduce the conveyance error caused by the outer diameter shape tolerance of the pair of conveyance rollers 12, as previously mentioned.

The identification module 26 can identify the type of the paper sheet, and send a identified result to the control unit 16. The control unit 16 can determine whether the current origin position matches the type of the paper sheet. If the current origin position matches the type of the paper sheet, the control unit 16 does not change the origin position, such that after the paper sheet is separated from the pair of conveyance rollers 12, the drive unit 14 drives the pair of conveyance rollers 12 to continue to rotate to the current origin position to stop. If the current origin position does not match the type of the paper sheet, the control unit 16 can change the origin position, such that after the paper sheet is separated from the pair of conveyance rollers 12, the drive unit 14 drives the pair of conveyance rollers 12 to continue to rotate to a changed origin position to stop. That is, when the paper sheet conveyance device 10 conveys different types of paper sheet, the control unit 16 can select different origin positions as the predetermined position where the pair of conveyance rollers 12 stop rotating. In the two cases that the control unit 16 changes and does not change the origin position, convey processes of the paper sheet by the paper sheet conveyance device 10 is substantially the same, except that the predetermined position where the pair of conveyance rollers 12 stops rotating is changed in the former case and remains unchanged in the latter case.

The identification module 26 may have any possible construction, as long as it is applicable to the present disclosure.

According to some embodiments, the paper sheet conveyance device 10 further includes a detection module 28. The detection module 28 is adapted to detect a weigh per unit area of the paper sheet. The control unit 16 is configured to determine whether to change the origin position based on a detection result of the detection module 28. Changing the origin position can avoid the paper sheet from impacting a same position on the pair of conveyance rollers 12 all the time, thereby reducing wear of the pair of conveyance rollers 12 by the paper sheet, which can be conducive to improving a service life of the pair of conveyance rollers 12, and further helps to reduce the conveyance error caused by the outer diameter shape tolerance of the pair of conveyance rollers 12, as previously mentioned.

The detection module 28 can detect the weight per unit area of the paper sheet, and send a detected result to the control unit 16. The control unit 16 can determine whether the current origin position matches the weight per unit area of the paper sheet. If the current origin position is matches the weight per unit area of the paper sheet, the control unit 16 does not change the origin position, such that after the paper sheet is separated from the pair of conveyance rollers 12, the drive unit 14 drives the pair of conveyance rollers 12 to continue to rotate to the current origin position to stop. If the current origin position does not match the weight per unit area of the paper sheet, the control unit 16 can change the origin position, such that after the paper sheet is separated from the pair of conveyance rollers 12, the drive unit 14 drives the pair of conveyance rollers 12 to continue to rotate to a changed origin position to stop. That is, when the paper sheet conveyance device 10 conveys paper sheets of different weights per unit area, the control unit 16 can select different origin positions as the predetermined position where the pair of conveyance rollers 12 stop rotating. In the two cases that the control unit 16 changes and does not change the origin position, convey processes of the paper sheet by the paper sheet conveyance device 10 is substantially the same, except that the predetermined position where the pair of the conveyance rollers 12 stop rotating is changed in the former case and remains unchanged in the latter case.

The detection module 28 may have any possible construction, as long as it is applicable to the present disclosure.

As shown in FIGS. 1 and 2, in some embodiments, the pair of conveyance rollers 12 includes a driving roller 30 and a driven roller 32. The driving roller 30 may be connected with the drive unit 14, be driven by the drive unit 14 and rotate, and drive the driven roller 32 to rotate together. Normally, when the paper sheet breaks into the pair of conveyance rollers 12, the break-in site of the paper sheet is located at the driving roller 30. That is, the paper sheet contacts with the driving roller 30 when breaking into the pair of conveyance rollers 12, and then is clamped between the driving roller 30 and the driven roller 32 and conveyed. The driving roller 30 is generally made of rubber. The driven roller 32 is generally made of a non-rubber material. However, the paper sheet often causes impact to the driving roller 30 when breaking into the pair of conveyance rollers 12 in this way, and thus wears the driving roller 30, thereby affecting a service life of the pair of conveyance rollers 12. The break-in site of the paper sheet is located at the driven roller 32, which can reduce wear of the driving roller 30 made of rubber by the paper sheet, be conducive to improving a service life of the pair of conveyance rollers 12, and help to reduce the conveyance error caused by the outer diameter shape tolerance of the pair of conveyance rollers 12.

For example, the driving roller 30 and the driven roller 32 of the pair of conveyance rollers 12 may be configured that at least a front end of the paper sheet is lower than a plane that includes an inner common tangent of the driving roller 30 and the driven roller 32 and is perpendicular to a plane defined by central axes of the driving roller 30 and the driven roller 32. As such, the break-in site of the paper sheet can be positioned at the driven roller 32. The driving roller 30 and the driven roller 32 each may have any possible construction, as long as it is applicable to the present disclosure.

As shown in FIG. 3, in some embodiments, the paper sheet conveyance device 10 further includes a paper sheet sensor 34. The paper sheet sensor 34 may be at a predetermined distance from the pair of conveyance rollers 12, and is adapted to sense the paper sheet that is about to pass through the pair of conveyance rollers 12. The control unit 16 is configured to determine whether to adjust the rotation speed of the pair of conveyance rollers 12 based on a sensing result of the paper sheet sensor 34 and data output from the drive unit 14.

The paper sheet sensor 34 can sense whether there is paper sheet or not, and send a sensing result to the control unit 16. The drive unit 14 may send output data, such as steps, to the control unit 16. When the control unit 16 receives the sensing result of the paper sheet sensor 34 as there is a paper sheet, that is, when the paper sheet sensor 34 senses that there is a paper sheet about to pass through the pair of conveyance rollers 12, the control unit 16 can determine whether the data output from the drive unit 14 is consistent with a predetermined output data during a period of time from the pair of conveyance rollers 12 starting rotating to the paper sheet sensor 34 sensing the paper sheet. If the control unit 16 determines that the data output from the drive unit 14 is consistent with the predetermined output data in this period of time, the control unit 16 determines not to adjust the rotation speed of the pair of conveyance rollers 12. This means that, during this period of time, the rotation of the pair of conveyance rollers 12 has reached a predetermined rotation, and during the paper sheet continues to be conveyed for a predetermined distance and then breaks into the pair of conveyance rollers 12, the rotation speed of the pair of conveyance rollers 12 can remain unchanged. If the control unit 16 determines that the data output from the drive unit 14 is inconsistent with the predetermined output data in this period of time, the control unit 16 determines to adjust the rotation speed of the pair of conveyance rollers 12. This means that, during this period of time, the rotation of the pair of conveyance rollers 12 has not reached the predetermined rotation. The control unit 16 can adjust the rotation speed of the pair of conveyance rollers 12 based on a difference between the data output from the drive unit 14 and the predetermined output data in this period of time, and then control the drive unit 14 to drive the pair of conveyance rollers 12 to rotate at an adjusted speed in a process of subsequently passing a predetermined distance, to ensure that when different sheets of paper sheet with a same size break into the pair of conveyance rollers 12, the rotational phase of the pair of conveyance rollers 12 is consistent. That is, it is ensured that for different paper sheets with a same size, origin positions of the pair of conveyance rollers 12 are the same, which can reduce the conveyance error caused by the outer diameter shape tolerance of the pair of conveyance rollers 12.

The paper sheet sensor 34 may have any applicable construction. For example, the paper sheet sensor 34 may include a reflective sensor or a transmissive sensor, and the like. The reflective sensor may be, for example, a reflective photoelectric sensor or a reflective fiber optic sensor.

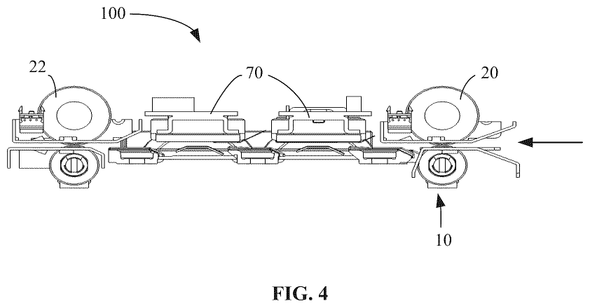

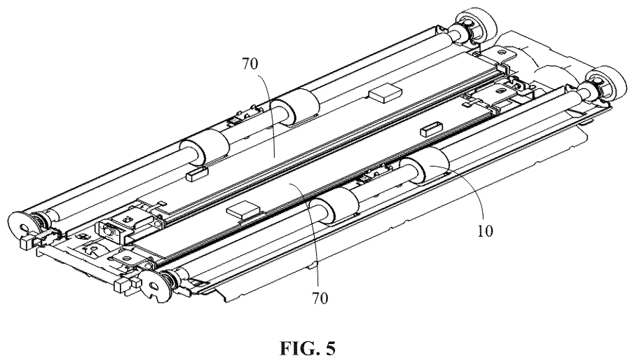

FIG. 4 is a schematic side view of an image forming device according to an embodiment of the present disclosure, wherein the straight arrow indicates a direction along which the paper sheet is conveyed. FIG. 5 is a schematic brief stereo view of the image forming device in FIG. 4. As shown in FIGS. 4 and 5, some other embodiments of the present disclosure provide an image forming device 100. The image forming device 100 includes the paper sheet conveyance device 10 according to any one of the foregoing embodiments; and an image reading part (i.e., image reader) 70 adapted to read a paper surface of the paper sheet passing through the pair of conveyance rollers 12, and the control unit 16 is configured to generate size data corresponding to the paper surface based on a time it takes for the paper sheet to pass through the pair of conveyance rollers 12.

As such, as mentioned above, a paper sheet conveyance error of the image forming device 100 including the paper sheet conveyance device 10 can be reduced.

The image reading part 70 may be positioned between the upstream conveyance roller pair 20 and the downstream conveyance roller pair 22 of the paper sheet conveyance device 10 along the conveyance route of the paper sheet. The paper sheet may enter the image reading part 70 and be read thereby after passing through the upstream conveyance roller pair 20, and then, break into the downstream conveyance roller pair 22 and continue to be conveyed until being separated from the downstream conveyance roller pair 22. The image reading part 70 can read the paper surface of the paper sheet that passes through the pair of conveyance rollers 12, for example, an image of the paper surface, and can send a reading result to the control unit 16. The control unit 16 can receive the reading result sent from the image reading part 70, and can calculate a time it takes for the paper sheet to pass through the pair of conveyance rollers 12, and then can calculate a length of the paper sheet based on the time it takes for the paper sheet to pass through the pair of conveyance rollers 12 and the rotation speed of the pair of conveyance rollers 12 and/or the data (for example, steps) output from the drive unit 14, and can directly calculate a width of the paper sheet.

Unless otherwise specified, the size data corresponding to the paper surface herein may be the length and the width of the paper sheet. The length of the paper sheet refers to a size of the paper sheet in the conveyance direction thereof. The width of the paper sheet refers to a size of the paper sheet in a direction perpendicular to the conveyance direction thereof.

Under a condition that the paper sheet conveyance error of the paper sheet conveyance device 10 of the image forming device 100 is reduced, for paper sheets with a same size, consistency of timing that the image reading part 70 reads the paper surfaces of the paper sheets and the size data, generated by the control unit 16 based on the reading result of the image reading part 70, corresponding to the paper surface can be improved, which is conducive to reducing a reading error of the size data of the paper sheet by the image forming device 100.

The image forming device 100 may be any device used for forming an image, as long as it is applicable to the present disclosure. For example, the image forming device 100 may be a printer, a scanner, or other device including a reading assembly and/or a scanning assembly. The image reading part 70 may have any applicable construction.

According to some embodiments, the control unit 16 is configured to: generate size data of the paper sheet at different origin positions, respectively, with different sites in a circumferential direction of the pair of conveyance rollers 12 being used as the origin positions of the pair of conveyance rollers; calculate a first correction value of the size data of the paper sheet at the different origin positions, respectively; and obtain a reading result based on the size data of the paper sheet at the different origin positions and the corresponding first correction value.

As such, the reading error of the paper sheet by the image forming device 100 can be reduced, and accuracy of the reading result of the image forming device 100 can be improved.

The control unit 16 may calculate the first correction values of the size data of the paper sheet at the different origin positions as follows:
conveying a reference paper sheet using the paper sheet conveyance device 10 of the image forming device 100;
calculating a shape of the pair of conveyance rollers 12 according to a velocity curve formed by rotation of the pair of conveyance rollers 12 for 1 turn;
recording an initial phase when the pair of conveyance rollers 12 starts to rotate and an end phase when the pair of conveyance rollers 12 stops rotating, respectively, during conveyance of the reference paper sheet; and
calculating rotations of the pair of conveyance rollers 12 and a phase difference between the initial phase and the end phase after conveyance of the reference paper sheet is completed, to calculate the first correction value based on the phase difference.

Specifically, the velocity curve upon rotation of the pair of conveyance rollers 12 for 1 turn is multiplied by the rotation time as a conveyance distance of the pair of conveyance rollers 12 rotating for 1 turn. When the paper sheet is actually conveyed, the pair of conveyance rollers 12 may rotate for (N+m) turns (N is a natural number, m is a decimal number between 0 and 1). A conveyance amount for m turns (phase difference) may be calculated according to a rotation curve. A difference between this conveyance amount and a theoretical conveyance amount may be used as the first correction value of the size data (the conveyance distance of the pair of conveyance rollers 12) of the paper sheet.

A sum of the size data of the paper sheet at the different origin positions and the corresponding first correction values is a reading result of the image forming device 100 for the paper sheet. This reading result may be the length of the paper sheet.

According to some embodiments, the image reading part 70 is adapted to read a front end and/or a tail end and/or a side of the paper sheet that passes through the pair of conveyance rollers 12.

The image reading part 70 can send an read image signal of the front end and/or the tail end and/or the side of the paper sheet to the control unit 16. The control unit 16 can calculate a time from the image reading part 70 reading the front end of the paper sheet to the image reading part 70 reading the tail end of the paper sheet, and can calculate the rotation of the pair of conveyance rollers 12 and/or the data output from the drive unit 14 during this time, thereby obtaining the length data of the paper sheet. In addition, the control unit 16 can calculate a size of the side of the paper sheet as the width data of paper sheet.

Unless otherwise specified, the rotation of the pair of conveyance rollers 12 herein may be a product of the rotation speed and the rotation time of the pair of conveyance rollers 12.

According to some embodiments, the control unit 16 is configured to calculate a second correction value based on the data output from the drive unit 14 and the rotation of the pair of conveyance rollers 12 when the image reading part 70 reads the front end of the paper sheet; and obtain a reading result based on the size data of the paper sheet and the second correction value.

As such, the reading error of the paper sheet by the image forming device 100 can be reduced, and accuracy of the reading result of the image forming device 100 can be improved.

When the image reading part 70 reads the front end of the paper sheet, the control unit 16 can compare the data output, such as steps, from the drive unit 14 from beginning to convey the paper sheet to now, and the rotation of the pair of conveyance rollers 12. If the data output from the drive unit 14 corresponds to the rotation of the pair of conveyance rollers 12 so far, the size data of the paper sheet generated as above by the image forming device 100 is taken as the reading result. If the data output from the drive unit 14 does not correspond to the rotation of the pair of conveyance rollers 12, a difference in the rotation of the pair of conveyance rollers 12 is calculated as the second correction value based on the data output from the drive unit 14. In addition, a sum of the size data of the paper sheet generated as above by the image forming device 100 and the second correction value can be taken as the reading result.

According to some embodiments, the control unit 16 is configured to calculate a second correction value based on the data output from the drive unit 14 and the rotation of the pair of conveyance rollers 12 when the image reading part 70 reads the front end of the paper sheet; and adjust the rotation speed of the pair of conveyance rollers 12 based on the second correction value.

As such, the reading error of the paper sheet by the image forming device 100 can be reduced, and accuracy of the reading result of the image forming device 100 can be improved.

Calculation of the second correction value here is the same as above. The control unit 16 can adjust the rotation speed of the pair of conveyance rollers 12 based on the second correction value, such that the rotation of the pair of conveyance rollers 12 corresponds to the data output from the drive unit 14, and the size data of the paper sheet generated as above by the image forming device 100 is more accurate.

The embodiments of the present disclosure can be conducive to reducing a conveyance error of the paper sheet conveyance device, and can be helpful for the image forming device including the paper sheet conveyance device to play a good function.

Various embodiments described above and shown in the accompanying drawings are only for illustrative purposes of the present disclosure and are not all of the present disclosure. Within the scope of the basic technical idea of the present disclosure, any form of change to the present disclosure made by those skilled in the art is within the scope of protection of the present disclosure.

What is claimed is:

1. A paper sheet conveyance device, comprising:
a pair of conveyance rollers that rotates to convey a paper sheet passing through them; and
a driver that drives the pair of conveyance rollers to rotate, and further comprising:
a hardware processor that controls the driver to drive the pair of conveyance rollers to rotate, such that before the paper sheet breaks into the pair of conveyance rollers, a rotation speed of the pair of conveyance rollers reaches a predetermined conveyance speed, and after the paper sheet is separated from the pair of conveyance rollers, the pair of conveyance rollers continue to rotate to a predetermined position to stop.

2. The paper sheet conveyance device according to claim 1, wherein the predetermined position is an origin position of the pair of conveyance rollers.

3. The paper sheet conveyance device according to claim 1, further comprising a position sensor that detects a rotational phase of the pair of conveyance rollers; and
the hardware processor controls the driver to drive the pair of conveyance rollers to continue rotating or stop rotating based on a detection result of the position sensor.

4. The paper sheet conveyance device according to claim 1, wherein the pair of conveyance rollers comprise an upstream conveyance roller pair and a downstream conveyance roller pair; and
the hardware processor controls the driver to drive the upstream and downstream conveyance roller pairs to rotate, respectively, to convey the paper sheet passing through them.

5. The paper sheet conveyance device according to claim 2, further comprising a recording module that records a number of the paper sheets passing through the pair of conveyance rollers and/or that records a rotation time of the pair of conveyance rollers; and
the hardware processor determines whether to change the origin position of the pair of conveyance rollers based on a result of the recording module.

6. The paper sheet conveyance device according to claim 2, further comprising an identification module that identifies a type of the paper sheet; and
the hardware processor determines whether to change the origin position of the pair of conveyance rollers based on the type of the paper sheet.

7. The paper sheet conveyance device according to claim 2, further comprising a detection module that detects a weight per unit area of the paper sheet; and
the hardware processor determines whether to change the origin position of the pair of conveyance rollers based on a result of the detection module.

8. The paper sheet conveyance device according to claim 1, wherein the pair of conveyance rollers comprise a driving roller and a driven roller, and a break-in site of the paper sheet is located at the driven roller.

9. The paper sheet conveyance device according to claim 1, further comprising a paper sheet sensor that is at a predetermined distance from the pair of conveyance rollers and is adapted to sense the paper sheet that is about to pass through the pair of conveyance rollers; and
the hardware processor determines whether to adjust the rotation speed of the pair of conveyance rollers based on a sensing result of the paper sheet sensor and data output from the driver.

10. An image forming device, comprising:
the paper sheet conveyance device according to claim 1; and
an image reader that reads a paper surface of the paper sheet passing through the pair of conveyance rollers,
wherein the hardware processor of the paper sheet conveyance device generates size data corresponding to the paper surface based on a time it takes for the paper sheet to pass through the pair of conveyance rollers.

11. The image forming device according to claim 10, wherein the hardware processor:
generates size data of the paper sheet at different origin positions, respectively, with different sites in a circumferential direction of the pair of conveyance rollers being used as the origin positions of the pair of conveyance rollers;
calculates a first correction value of the size data of the paper sheet at the different origin positions, respectively; and
obtains a reading result based on the size data of the paper sheet at the different origin positions and the corresponding first correction value.

12. The image forming device according to claim 10, wherein the image reader reads a front end and/or a tail end and/or a side of the paper sheet that passes through the pair of conveyance rollers.

13. The image forming device according to claim 10, wherein the hardware processor:
calculates a second correction value based on data output from the driver of the paper sheet conveyance device and a rotation of the pair of conveyance rollers when the image reader reads the front end of the paper sheet; and
obtains a reading result based on the size data of the paper sheet and the second correction value.

14. The image forming device according to claim 10, wherein the hardware processor:
calculates a second correction value based on data output from the driver of the paper sheet conveyance device and a rotation of the pair of conveyance rollers when the image reader reads the front end of the paper sheet; and
adjusts the rotation speed of the pair of conveyance rollers based on the second correction value.
